(19) United States
(12) Patent Application Publication
(10) Pub. No.: US 2012/0148205 A1
(43) Pub. Date: Jun. 14, 2012

(54) IMAGE SENSOR AND MANUFACTURING METHOD OF THE SAME

(75) Inventors: Byoung-Jun PARK, Iksan (KR); Sang Hyeob Kim, Daejeon (KR); Myung-Ae Chung, Daejeon (KR); Kyu-Sang Shin, Jeonju (KR)

(73) Assignee: Electronics and Telecommunications Research Institute, Daejeon (KR)

(21) Appl. No.: 13/289,460

(22) Filed: Nov. 4, 2011

(30) Foreign Application Priority Data
Dec. 8, 2010 (KR) 10-2010-0125011

(51) Int. Cl. G02B 6/06

(52) U.S. Cl. 385/119

(57) ABSTRACT

Provided is an image sensor and a method of manufacturing the image sensor which can remove a dead zone and increase light collection efficiency. The sensor thereof includes a substrate that includes a plurality of pixel areas disposed in a matrix form, a plurality of photoelectric conversion devices formed at the pixel areas, a plurality of optical waveguide layers formed on the plurality of photoelectric conversion devices, a color filter layer formed on the plurality of optical waveguide layers, and upper and lower microlenses formed on and under the color filter layer, respectively. The upper and lower microlenses are arranged by alternating in longitudinal and transverse directions of the pixel area on the plurality of optical waveguide layers.

### CROSS-REFERENCE TO RELATED APPLICATIONS

This U.S. non-provisional patent application claims priority under 35 U.S.C. §119 of Korean Patent Applications No. 10-2010-0125011, filed on Dec. 8, 2010, the entire contents of which are hereby incorporated by reference.

### BACKGROUND

The present disclosure herein relates to an image sensor and a manufacturing method of the same, and more particularly, to an image sensor that generates electrical image signals by receiving light and a manufacturing method of the image sensor.

Recently, researches and developments of image sensors, which are used in a digital camera, a camcorder, a process control system (PCS), and a surveillance camera, etc., are being actively in progress due to the advances in computer and telecommunication industries. An image sensor may include photoelectric conversion devices that receive light to convert into electric signals, and microlenses that focus external light on the photoelectric conversion devices. The photoelectric conversion devices and the microlenses may be arranged in a matrix form on a substrate. The photoelectric conversion devices may include a PN junction layer. The microlenses can improve sensitivity of the image sensor.

The microlenses can focus the external light on the photoelectric conversion devices. However, a general image sensor may include a dead zone generated from a manufacturing process margin between the microlenses. There is a disadvantage that the dead zone decreases aperture ratio such that light collection efficiency can be decreased.

### SUMMARY

The present disclosure provides an image sensor capable of removing a dead zone and a manufacturing method of the image sensor.

The present disclosure also provides an image sensor capable of increasing or maximizing light collection efficiency and a manufacturing method of the image sensor.

Embodiments of the inventive concept provide an image sensor including: a substrate including a plurality of pixel areas arranged in a matrix form; a plurality of photoelectric conversion devices formed at the pixel areas; a plurality of optical waveguide layers formed on the plurality of photoelectric conversion devices; a color filter layer formed on the plurality of optical waveguide layers; and upper and lower microlenses formed on and under the color filter layer, respectively. Herein, the upper and lower microlenses may be arranged by alternating in longitudinal and transverse directions of the pixel area on the plurality of optical waveguide layers.

In some embodiments, the upper and lower microlenses may be arranged in a diagonal direction on one pixel area.

In other embodiments, the pixel areas may include a red color unit pixel, a blue color unit pixel, and a plurality of green color unit pixels, wherein the upper microlenses may be disposed on the red color unit pixel and the blue color unit pixel of the color filter layer, and the lower microlenses may be disposed under the green color unit pixels of the color filter layer.

In still other embodiments, the upper and lower microlenses may be connected to boundaries between the red color unit pixel, the blue color unit pixel, and the plurality of green color unit pixels on and under the color filter layer, respectively.

In even other embodiments, the image sensor may further include interconnection layers and interlayer dielectrics formed on the substrate corresponding to the boundaries between the red color unit pixel, the blue color unit pixel, and the plurality of green color unit pixels.

In yet other embodiments, the lower microlens may include a convex lens having a higher refractive index than the optical waveguide layer.

In further embodiments, the lower microlens may include a concave lens having a lower refractive index than the optical waveguide layer.

In still further embodiments of the inventive concept, a method of manufacturing an image sensor include forming a plurality of photoelectric conversion devices in pixel areas of a substrate; forming an optical waveguide layer on the photoelectric conversion devices; forming lower microlenses on the optical waveguide layer corresponding to every second unit pixel in longitudinal and transverse directions of the pixel areas; forming a color filter on the lower microlens and the optical waveguide layer; and forming an upper microlens on the unit pixel of the color filter layer alternating with the lower microlens.

In even further embodiments, the forming of the lower microlens may include forming a sacrificial mask layer having a curved surface in a concave or a convex form on the optical waveguide layer, removing the sacrificial mask layer while maintaining the curved surface and removing up to an upper surface of the optical waveguide layer, and forming a lower microlens embedding the curved surface.

In yet further embodiments, the lower microlens may include a convex lens formed along the curved surface in a concave form when the lower microlens has a higher refractive index than the optical waveguide layer.

In much further embodiments, the lower microlens may include a concave lens formed along the curved surface in a convex form when the lower microlens has a lower refractive index than the optical waveguide layer.

In still much further embodiments, the sacrificial mask layer may be printed on the optical waveguide layer.

In even much further embodiments, the sacrificial mask layer and the optical waveguide layer may be removed by a dry etching method using an etching gas having the same etch rate to each other.

In yet much further embodiments, the forming of the optical waveguide layer may include stacking interconnection layers and interlayer dielectrics on the substrate, forming a trench by removing the interlayer dielectrics on the photoelectric conversion device, and forming an optical waveguide layer inside the trench and on the interconnection layers and the interlayer dielectrics.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1A is a plan view illustrating an image sensor according to embodiments of the inventive concept;

FIG. 1B is a enlarged plan view of the pixel area of FIG. 1A;

FIG. 2 is a cross-sectional view illustrated by cutting on the line I-I′ of FIG. 1B;

FIG. 3A is a cross-sectional view illustrating the upper portion and microlenses of FIG. 2;

FIG. 3B is a cross-sectional view illustrating a dead zone generated between general upper microlenses;

FIG. 4 is a perspective view illustrating the color filter layer and the upper and lower microlenses of FIG. 2;

FIGS. 5 through 13 are cross-sectional views illustrating a manufacturing method of an image sensor according to an embodiment of the inventive concept;

FIG. 14 is a cross-sectional view of an image sensor according to another embodiment of the inventive concept illustrated by cutting on the line I-I′ of FIG. 1B;

FIG. 15 is a cross-sectional view illustrating the upper and lower microlenses and the color filter layer of FIG. 14; and

FIGS. 16 through 20 are cross-sectional views illustrating a manufacturing method of an image sensor according to another embodiment of the inventive concept.

### DETAILED DESCRIPTION OF THE EMBODIMENTS

Preferred embodiments of the present invention will be described below in more detail with reference to the accompanying drawings. Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout.

In the following description, the technical terms are used only for explaining specific embodiments while not limiting the present invention. In the inventive concept, the terms of a singular form may include plural forms unless otherwise specified. The meaning of “include,” “comprise,” “including,” or “comprising,” specifies a property, a region, a fixed number, a step, a process, an element and/or a component but does not exclude other properties, regions, fixed numbers, steps, processes, elements and/or components. Since preferred embodiments are provided below, the order of the reference numerals given in the description is not limited thereto.

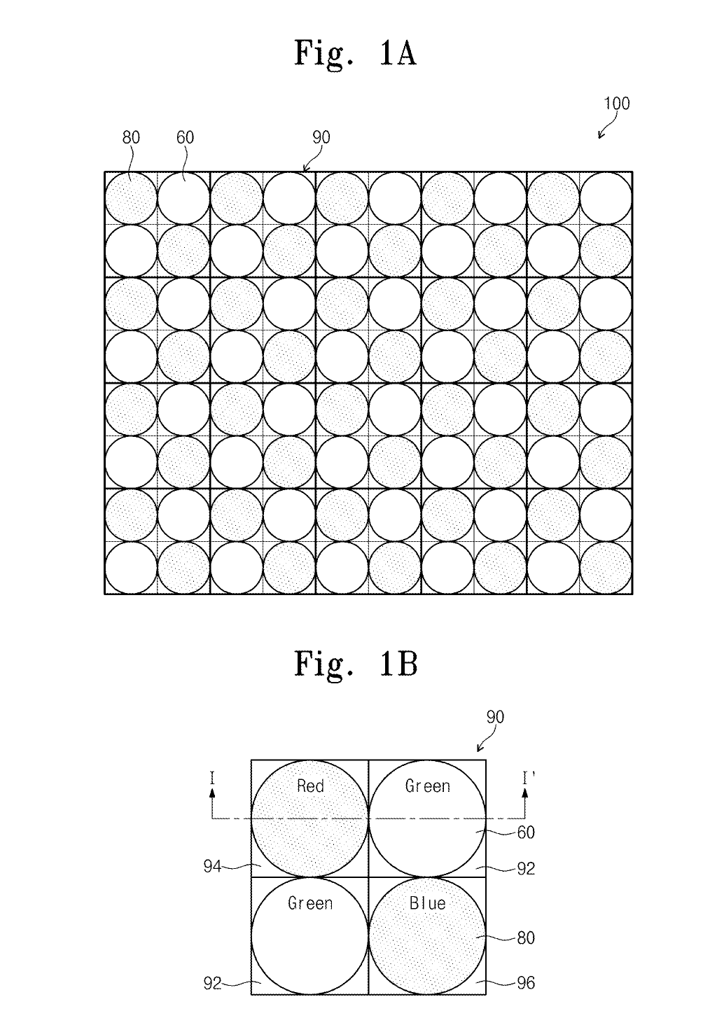

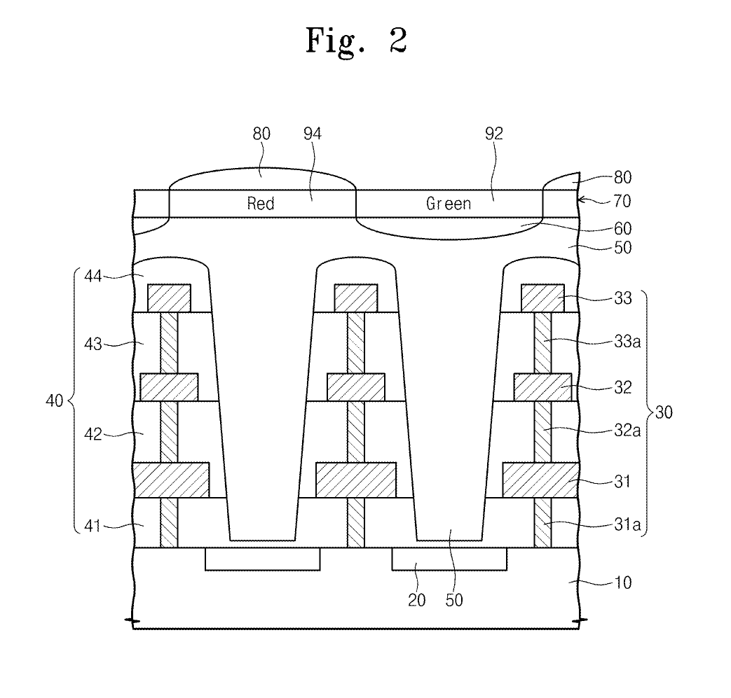

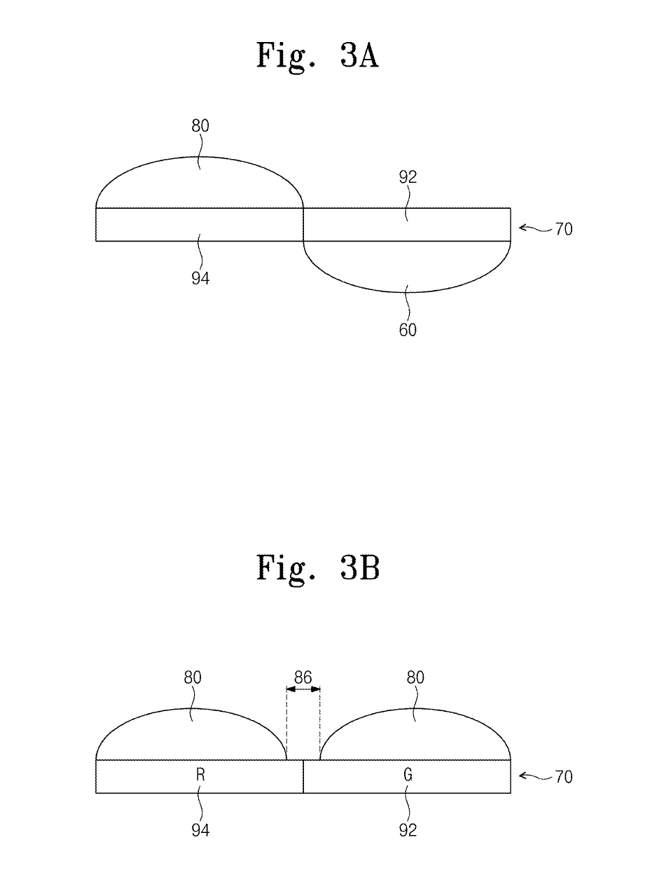

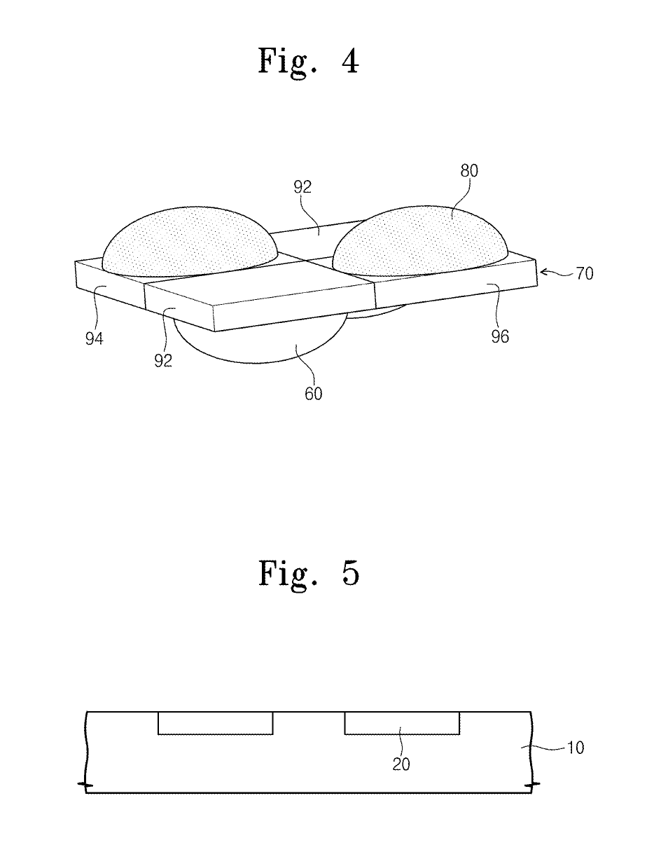

FIG. 1A is a plan view illustrating an image sensor according to embodiments of the inventive concept. FIG. 1B is a enlarged plan view of the pixel area of FIG. 1A. FIG. 2 is a cross-sectional view illustrated by cutting on the line I-I′ of FIG. 1B. FIG. 3A is a cross-sectional view illustrating the upper portion and microlenses of FIG. 2. FIG. 3B is a cross-sectional view illustrating a dead zone generated between general upper microlenses. FIG. 4 is a perspective view illustrating the color filter layer and the upper and lower microlenses of FIG. 2.

Referring to FIGS. 1 through 4, an image sensor 100 according to an embodiment of the inventive concept may include upper and lower microlenses 80 and 60 arranged on and under a color filter layer 70, respectively, by alternating in longitudinal and transverse directions in pixel areas 90 arranged in a matrix form. The upper and lower microlenses 80 and 60 may be connected to boundaries between unit pixels 92, 94 and 96 on and under the color filter layer 70. The upper and lower microlenses 80 and 60 may include a convex lens. The upper and lower microlenses 80 and 60 may be continuously arranged in a diagonal direction of the matrix, respectively.

Therefore, the image sensor 100 according to the embodiment of the inventive concept may generally remove a dead zone 86 generated between the upper microlenses 80. Also, the upper and lower microlenses 80 and 60 may be extended to the boundaries of the unit pixels 92, 94 and 96 so that light collection efficiency can be increased or maximized.

A photoelectric conversion device 20 may convert light applied through an optical waveguide layer 50 into an electric signal. For example, the photoelectric conversion device 20 may include a PN junction drived by at least one type of a charge coupled device (CCD) and complementary metal-oxide semiconductor (CMOS). The photoelectric conversion device 20 may be arranged in the pixel areas 90 arranged in the matrix form of a substrate 10. The photoelectric conversion device 20 may be arranged at a position which is defined by a skin interconnection line and a data interconnection line crossing each other. The skin interconnection line and the data interconnection line may be arranged at an edge of the photoelectric conversion device 20. The skin interconnection line and the data interconnection line may be electrically connected to interconnection layers 30 including a first contact plug 31a penetrating a first interlayer dielectric 41 and a first metal interconnection layer 31.

The interconnection layers 30 may be arranged on the periphery of the photoelectric conversion device 20. The interconnection layers 30 may further include a second contact plug 32a, a second metal interconnection layer 32, a third contact plug 33a, and a third metal interconnection layer 33. The first contact plug 31a may electrically connect the skin interconnection line or the data interconnection line on the substrate 10 and the first metal interconnection layer 31 by penetrating the first interlayer dielectric 41. The first metal interconnection layer 31 may be disposed on the first interlayer dielectric 41. The second contact plug 32a may electrically connect the first metal interconnection layer 31 and the second metal interconnection layer 32 separated in a vertical direction by a second interlayer dielectric 42. The second metal interconnection layer 32 may be disposed on the second interlayer dielectric 42. The third contact plug 33a may electrically connect the second metal interconnection layer 32 and the third metal interconnection layer 33 by penetrating a third interlayer dielectric 43.

Interlayer dielectrics 40 may electrically insulate the interconnection layers 30. The interlayer dielectrics 40 may include the first interlayer dielectric 41, the second interlayer dielectric 42, the third interlayer dielectric 43, and a fourth interlayer dielectric 44. For example, the interlayer dielectrics 40 may include at least one of a silicon oxide layer, a silicon nitride layer, and a silicon oxynitride layer. The interlayer dielectrics 40 may transmit light delivered to the photoelectric conversion device 20. If the optical waveguide layer 50 does not exist, light may be refracted or reflected at each boundary of the interlayer dielectrics 40. Therefore, the optical waveguide layer 50 composed of one transparent material may be disposed at an upper portion of the photoelectric conversion device 20 by replacing the interlayer dielectrics 40.

The optical waveguide layer 50 may be disposed in close proximity on the photoelectric conversion device 20. The optical waveguide layer 50 may be disposed in a cone shape between the interconnection layers 30 and the interlayer dielectrics 40. The optical waveguide layer 50 may have boundaries at sidewalls of the interlayer dielectrics 40. The optical waveguide layer 50 may be formed of a transparent material which is the same as or different from the interlayer dielectrics 40. The optical waveguide layer 50 may include a dielectric such as a silicon oxide layer having excellent transparency, or a polymer such as polyester and acryl.

The color filter layer 70 may filter light transmitted outer or the upper microlenses 80 into monochromatic light. For example, the color filter layer 70 may filter light having wavelength bands each corresponding to three primary colors of red, green and blue colors. Herein, the color filter layer 70 with the three primary colors may correspond to one of the pixel areas 90. Herein, one pixel area 90 may be described as the color filter layer 70 composed of the three primary colors of red, green and blue colors. For example, the pixel areas 90 may include two green color unit pixels 92 and each one of a red color unit pixel 94 and a blue color unit pixel 96. The two green color unit pixels 92 may be spaced apart from each other in the pixel areas 90 by the red color unit pixel 94 and the blue color unit pixel 96. Therefore, the two green color unit pixels 92 may be arranged in the diagonal direction in the square pixel areas 90.

The lower microlens 60 may focus light transmitted the color filter layer 70. The upper microlens 80 may focus light on the color filter layer 70. The plurality of upper and lower microlenses 80 and 60 may be arranged in the pixel areas 90 composed of four unit pixels 92, 94 and 96, respectively. For example, the lower microlenses 60 may be disposed under the two green color unit pixels 92 of the color filter layer 70. The upper microlenses 60 may be disposed on the red color unit pixel 94 and the blue color unit pixel 96 of the color filter layer 70.

The upper and lower microlenses 80 and 60 may have the same boundaries as the unit pixels 92, 94 and 96 of the color filter layer 70 in the longitudinal or the transverse direction of the pixel areas 90. As described above, the upper and lower microlenses 80 and 60 may be continuously arranged in the diagonal direction of the pixel areas 90.

Therefore, the image sensor 100 according to the embodiment of the inventive concept can remove the dead zone between the general upper microlenses 80. Also, the upper and lower microlenses 80 and 60 can increase or maximize the light collection efficiency toward the photoelectric conversion device 20 and the optical waveguide layer 50.

A manufacturing method of an image sensor 100 according to an embodiment of the inventive concept having the foregoing configuration will be described below.

FIGS. 5 through 13 are cross-sectional views illustrating the manufacturing method of the image sensor 100 according to the embodiment of the inventive concept.

Referring to FIG. 5, a photoelectric conversion device 20 is formed on a substrate 10. The photoelectric conversion device 20 may include a PN junction in which conductive impurities are implanted into the substrate 10. The PN junction may be drived by a CCD or a CMOS type.

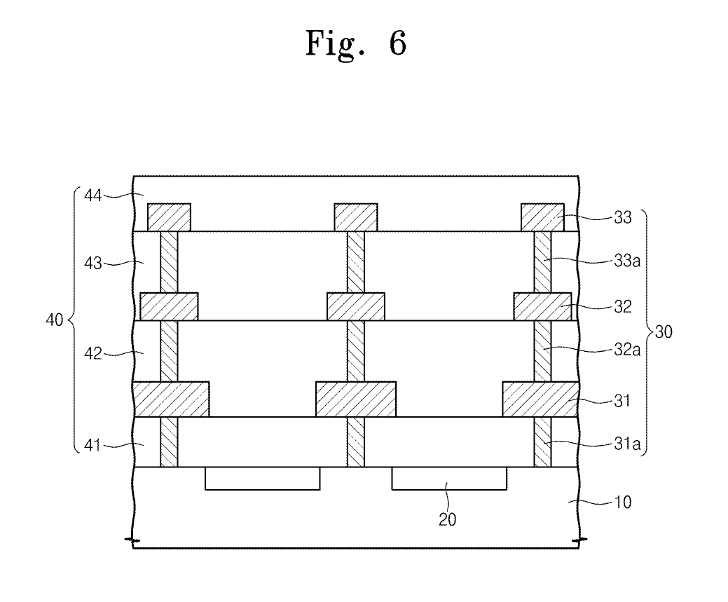

Referring to FIG. 6, interlayer dielectrics 40 and interconnection layers 30 are stacked on the photoelectric conversion device 20. The interlayer dielectrics 40 may include a silicon oxide layer, a silicon nitride layer, and a silicon oxynitride layer which are formed by a chemical vapor deposition method. The interconnection layers 30 may include at least one of gold, silver, copper, aluminum, tungsten, and molybdenum which are formed by the chemical vapor deposition method or a physical vapor deposition method. Specifically, a first interlayer dielectric 41 may be formed on the photoelectric conversion device 20. The first interlayer dielectric 41 at the periphery of the photoelectric conversion device 20 is etched by a photolithography process to form a first contact hole exposing the substrate 10, and a first contact plug 31a may be formed in the first contact hole. A first metal layer is formed on the first contact plug 31a, and a first metal interconnection layer 31 may be formed on the first contact plug 31a by patterning the first metal layer by the photolithography process. A second interlayer dielectric 42 may be deposited on the first metal interconnection layer 31. The second interlayer dielectric 42 on the first metal interconnection layer 31 is removed by the photolithography process, and a second contact hole, which exposes the first metal interconnection layer 31, may be formed. A second contact plug 32a may be formed in the second contact hole. A second metal layer may be formed on the second contact plug 32a and the second metal layer is patterned by the photolithography process to form a second metal interconnection layer 32. A third interlayer dielectric 43 may be deposited on the second metal interconnection layer 32. The third interlayer dielectric 43 is removed by the photolithography process to form a third contact hole exposing the second metal interconnection layer 32. A third contact plug 33a is formed in a third contact hole, and after forming a third metal layer on the third contact plug 33a, the third metal layer is patterned by the photolithography process to form a third metal interconnection layer 33. A fourth interlayer dielectric 44 may be formed on the third metal interconnection layer 33.

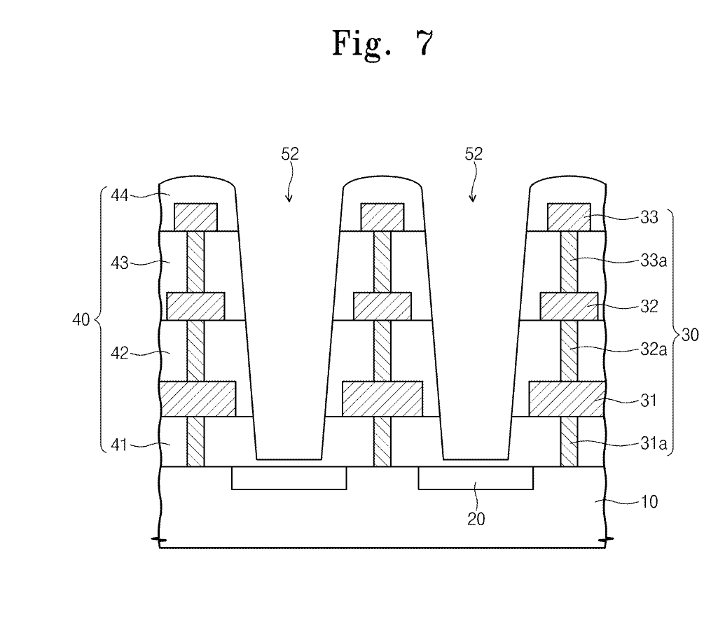

Referring to FIG. 7, a trench 52 is formed by removing the interlayer dielectrics 40 on the photoelectric conversion device 20. The interlayer dielectrics 40 on the photoelectric conversion device 20 may be removed by the photolithography process. For example, a photoresist pattern (not illustrated), which selectively exposes the interlayer dielectrics 40 on the photoelectric conversion device 20, is formed, and the trench 52, in which the interlayer dielectrics 40 are removed by an anisotropic dry etching method using the photoresist pattern as an etching mask, may be formed.

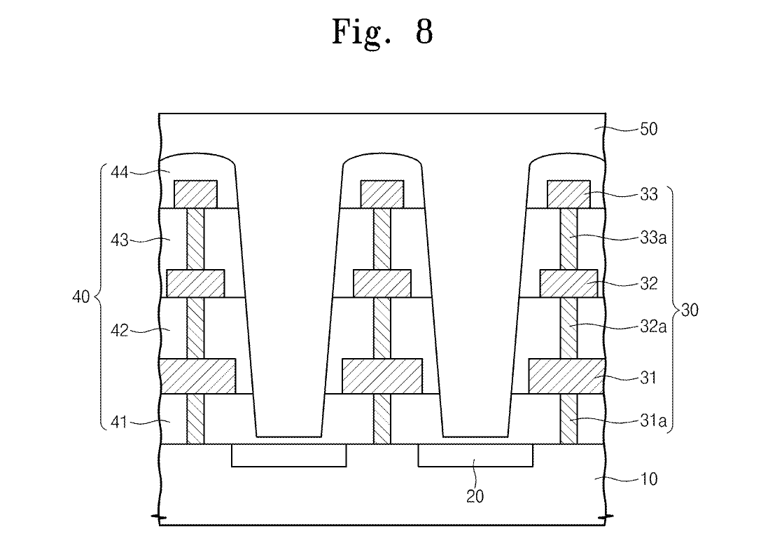

Referring to FIG. 8, an optical waveguide layer 50 is formed inside the trench 52 and an upper portion of the interlayer dielectrics 40. The optical waveguide layer 50 may include a dielectric such as a silicon oxide layer, or a transparent material including a polymer. The optical waveguide layer 50 may be planarized by a chemical mechanical polishing (CMP) method.

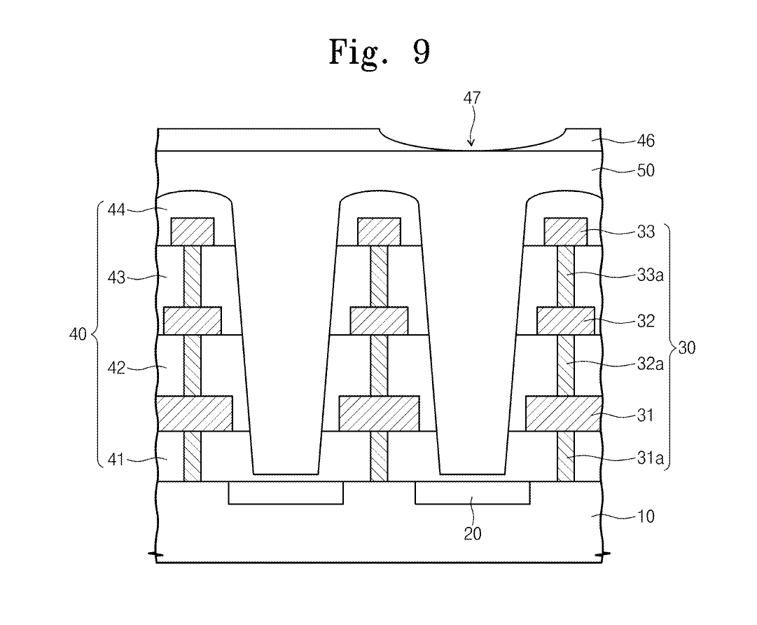

Referring to FIGS. 1 and 9, a first sacrificial mask layer 46 is formed on the optical waveguide layer 50. The first sacrificial mask layer 46 may have a first curved surface 47 in a concave form on the optical waveguide layer 50. The first curved surface 47 of the first sacrificial mask layer 46 may be formed at every second unit pixel in a longitudinal or a transverse direction of a pixel area 90, for example, green color unit pixels 92. The first sacrificial mask layer 46 may be printed on the optical waveguide layer 50. Also, the first sacrificial mask layer 46 may be first printed on a member such as a tape, and then adhered again to the optical waveguide layer 50. For example, the first sacrificial mask layer 46 may include a photoresist.

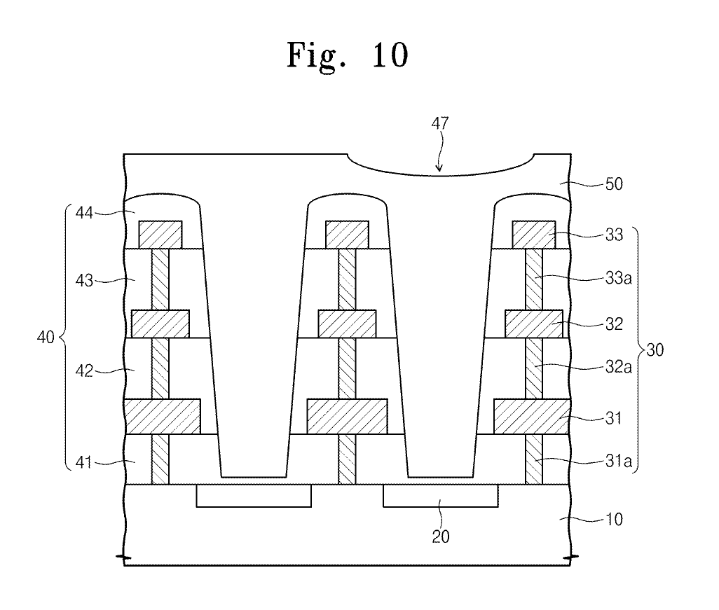

Referring to FIG. 10, while maintaining the first curved surface 47, the entire first sacrificial mask layer 46 and up to an upper surface of the optical waveguide layer 50 are removed. The first sacrificial mask layer 46 and the optical waveguide layer 50 may be removed by the anisotropic dry etching method. The dry etching method may use an etching gas having the same etch rate on the first sacrificial mask layer 46 and the optical waveguide layer 50.

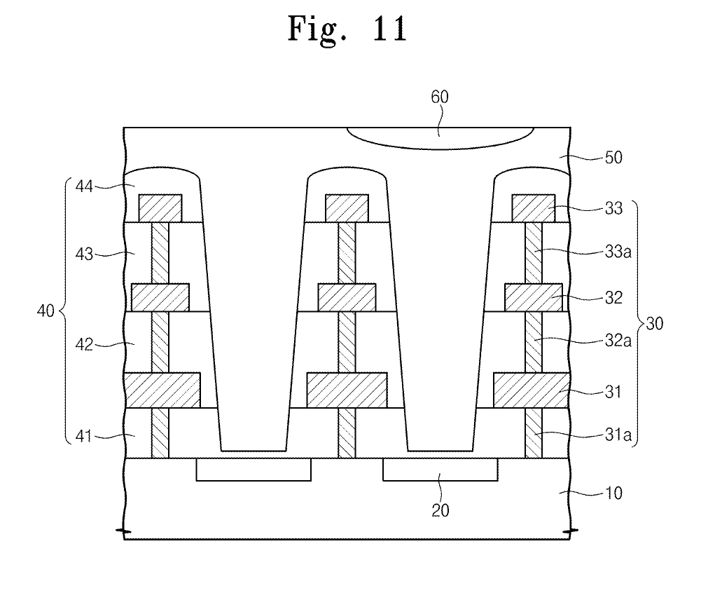

Referring to FIG. 11, on the first curved surface 47, a lower microlens 60 is formed of a material having a higher refractive index than the optical waveguide layer 50. The lower microlens 60 may include a polymer such as polymethyl methacrylate (PMMA) or a dielectric such as a silicon oxide layer.

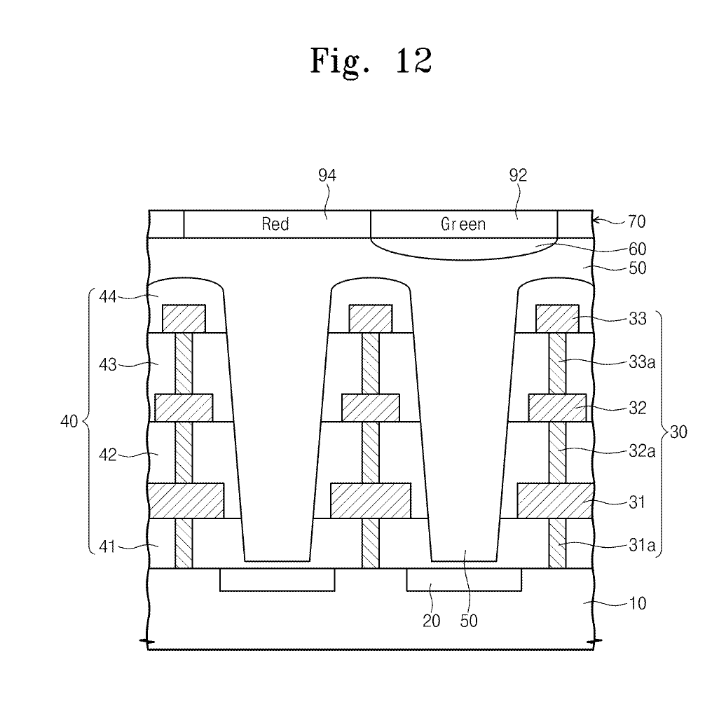

Referring to FIG. 12, a color filter layer 70 may be formed on the lower microlens 60 and the optical waveguide layer 50. The color filter layer 70 may include polymers having red, green, and blue colors, respectively. The color filter layer 70 may be formed by at least one photolithography process for each color. For example, the polymer having the red color is formed flat on the substrate 10, and then the red color of the color filter layer 70 may be patterned by the photolithography process. The green and blue colors of the color filter layer 70 may also be formed by the same method. The green color of the color filter layer 70 may be formed on the lower microlens 60. Herein, the green, red, and blue colors of the color filter layer 70 may correspond to a green color unit pixel 92, a red color unit pixel 94, and a blue color unit pixel 96, respectively. A boundary between the green color unit pixel 92 and the red color unit pixel 94 of the color filter layer 70 may be aligned with an edge of the lower microlens 60. A boundary between the green color unit pixel 92 and the blue color unit pixel 96 of the color filter layer 70 may be aligned with the edge of the lower microlens 60. Although not shown in the drawings, a planarizing layer may be further formed on the color filter layer 70 in order to planarize the substrate 10.

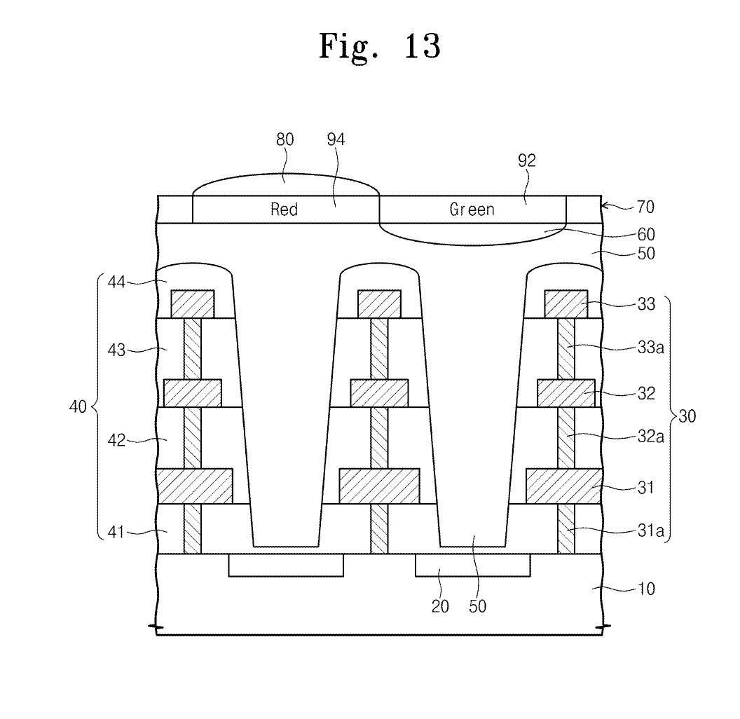

Referring to FIG. 13, an upper microlens 80 is formed on the color filter layer 70. The upper microlens 80 is patterned by the photolithography process on the substrate 10, and may include a reflowable photoresist. For example, the photoresist maybe formed on an entire surface of the substrate 10 by spin coating. The photoresist may be removed at a color boundary of the color filter layer 70 by the photolithography process. Also, the photoresist may be formed to a convex lens convexed over the lower microlens 60 by reflowing at a temperature of about 100° C. or more. The upper microlenses 80 may be formed on the red color unit pixel 94 and the blue color unit pixel 96. An edge of the upper microlens 80 may be aligned with the boundary between the red color unit pixel 94 and the green color unit pixel 92. Also, the edge of the upper microlens 80 may be aligned with the boundary between the blue color unit pixel 96 and the green color unit pixel 92. The upper microlens 80 may be formed on the color filter layer 70 independently from the lower microlens 60.

Therefore, the manufacturing method of the image sensor 100 according to the embodiment of the inventive concept can remove the dead zone.

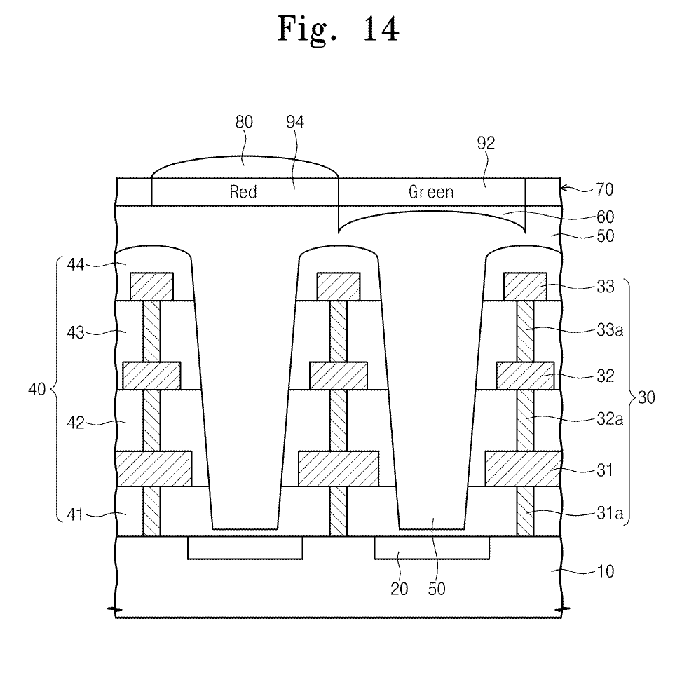

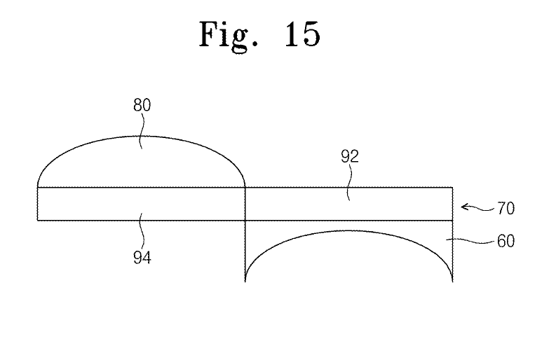

FIG. 14 is a cross-sectional view of an image sensor 100 according to another embodiment of the inventive concept illustrated by cutting on the line I-I′ of FIG. 1B. FIG. 15 is a cross-sectional view illustrating the upper and lower microlenses 80 and 60 and the color filter layer 70 of FIG. 14.

Referring to FIGS. 1, 14 and 15, the image sensor 100 according to another embodiment of the inventive concept may include a lower microlens 60 formed with a concave lens under the color filter layer 70 by alternating with the upper microlens 80 in the pixel areas 90. The upper microlens 80 may include a convex lens. The lower microlens 60 may have a lower refractive index than the upper microlens 80 and the optical waveguide layer 50. For example, the lower microlens 60 may include a silicon oxynitride layer (SiON) having a lower refractive index than a silicon oxide layer.

Therefore, the manufacturing method of the image sensor 100 according to the another embodiment of the inventive concept can remove the general dead zone 86. The upper microlens 80 with a convex lens and the lower microlens 60 with a concave lens can increase or maximize light collection efficiency.

A manufacturing method of an image sensor 100 according to another embodiment of the inventive concept having the foregoing configuration will be described below.

Referring to FIGS. 5 through 8, the photoelectric conversion device 20, the interconnection layers 30, the interlayer dielectrics 40, and the optical waveguide layer 50 are sequentially formed on the substrate 10.

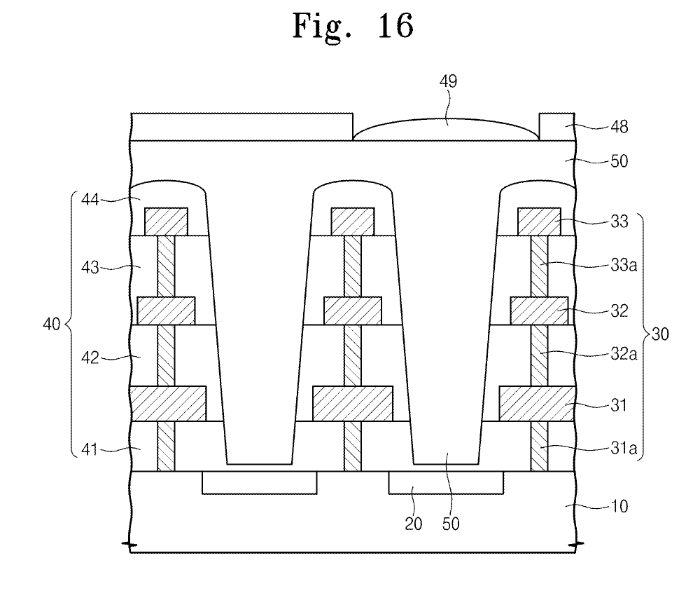

FIGS. 16 through 20 are cross-sectional views illustrating the manufacturing method of the image sensor 100 according to the another embodiment of the inventive concept.

Referring to FIG. 16, a second sacrificial mask layer 48 is formed on the optical waveguide layer 50. The second sacrificial mask layer 48 may have a second curved surface 49 in a convex form on the optical waveguide layer 50. The second curved surface 49 of the second sacrificial mask layer 48 may be formed at every second unit pixel in the longitudinal or the transverse direction of the pixel areas 90, for example, the green color unit pixels 92. The second sacrificial mask layer 48 may be printed on the optical waveguide layer 50. Also, the second sacrificial mask layer 48 may be first printed on a member such as a tape, and then adhered again to the optical waveguide layer 50. For example, the second sacrificial mask layer 48 may include a photoresist.

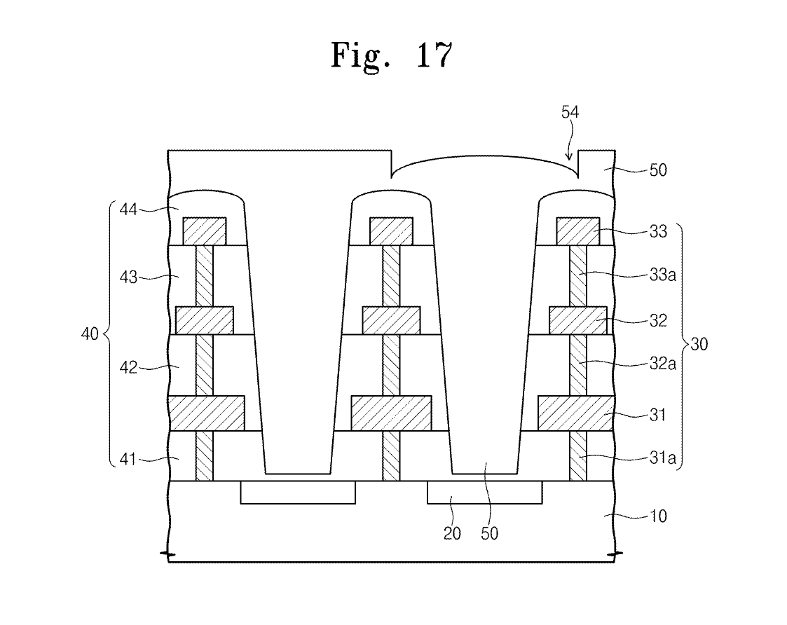

Referring to FIG. 17, while maintaining the second curved surface 49, the second sacrificial mask layer 48 and up to the upper surface of the optical waveguide layer 50 are removed. The second sacrificial mask layer 48 and the optical waveguide layer 50 may be removed by the anisotropic dry etching method. The dry etching method may use an etching gas having the same etch rate on the second sacrificial mask layer 48 and the optical waveguide layer 50.

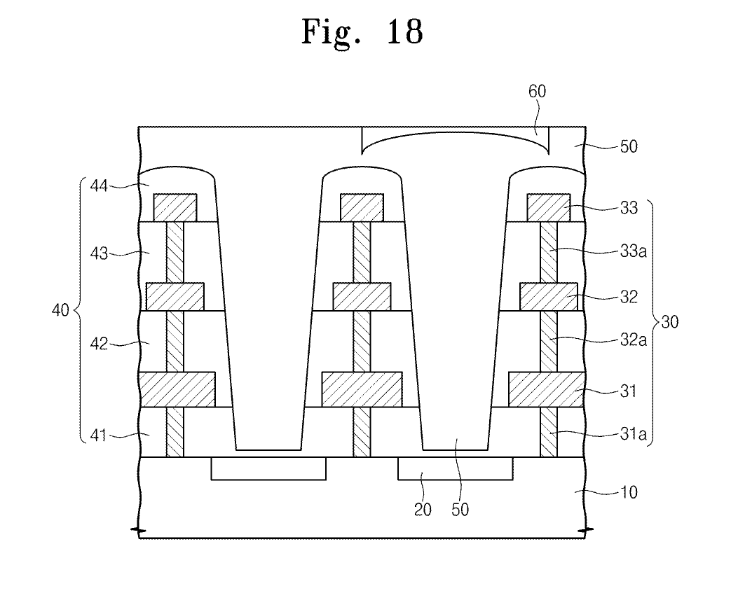

Referring to FIG. 18, on the second curved surface 49, a lower microlens 60 is formed of a material having a lower refractive index than the optical waveguide layer 50. The lower microlens 60 may include a silicon oxide layer. The lower microlens 60 may be embedded in the second curved surface 49 of the optical waveguide layer 50. The lower microlens 60 may have an upper surface with the same level as the optical waveguide 50.

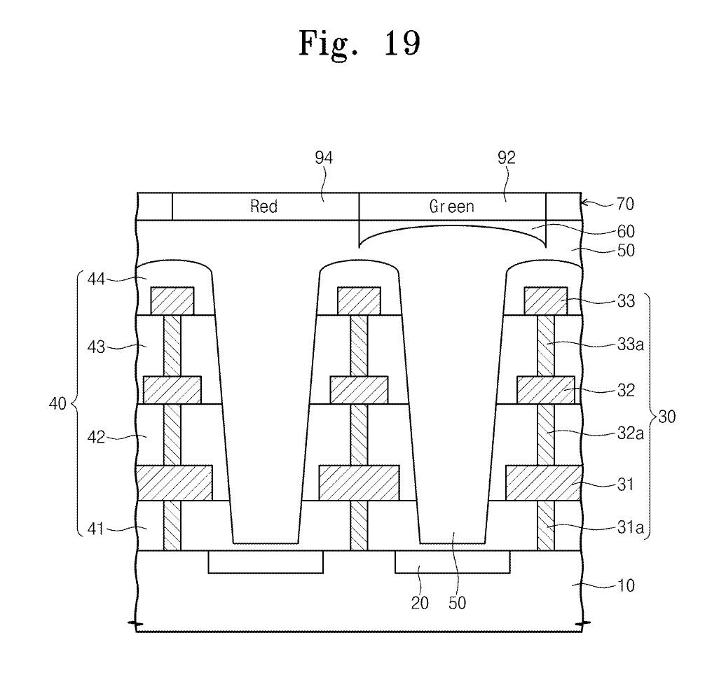

Referring to FIG. 19, a color filter layer 70 may be formed on the lower microlens 60 and the optical waveguide layer 50. The color filter layer 70 may include polymers having red, green, and blue colors, respectively. The color filter layer 70 may be formed by at least one photolithography process for each color. For example, the polymer having the red color is formed flat on the substrate 10, and then the red color of the color filter layer 70 may be patterned by the photolithography process. The green and blue colors of the color filter layer 70 may also be formed by the same method. The green color of the color filter layer 70 may be formed on the lower microlens 60. Herein, the green, red, and blue colors of the color filter layer 70 may correspond to a green color unit pixel 92, a red color unit pixel 94, and a blue color unit pixel 96, respectively. A boundary between the green color unit pixel 92 and the red color unit pixel 94 of the color filter layer 70 may be aligned with an edge of the lower microlens 60. A boundary between the green color unit pixel 92 and the blue color unit pixel 96 of the color filter layer 70 may be aligned with the edge of the lower microlens 60.

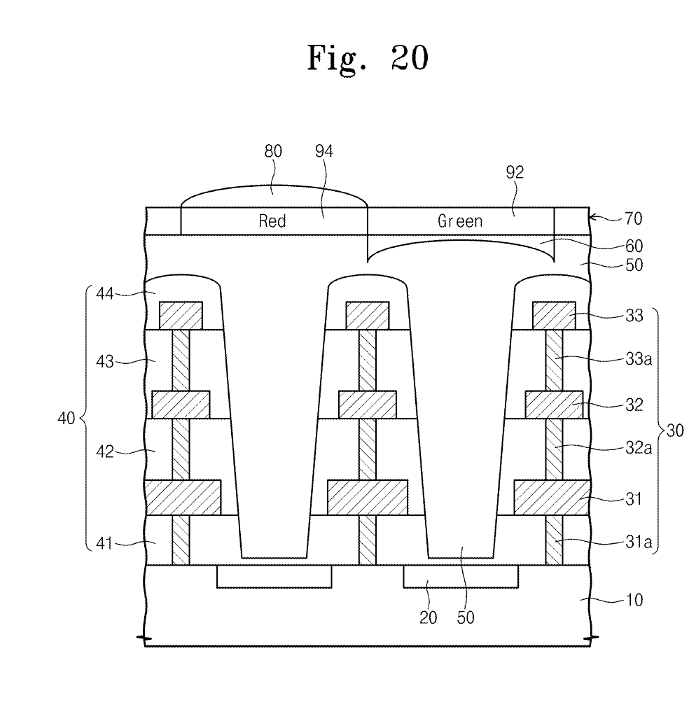

Referring to FIG. 20, an upper microlens 80 is formed on the color filter layer 70. The upper microlens 80 is patterned by the photolithography process on the substrate 10, and may include a reflowable photoresist. For example, the photoresist maybe formed on an entire surface of the substrate 10 by spin coating. The photoresist may be removed at a color boundary of the color filter layer 70 by the photolithography process. Also, the photoresist may be formed to a convex lens convexed over the lower microlens 60 by reflowing at a temperature of about 100° C. or more. The upper microlenses 80 may be formed on the red color unit pixel 94 and the blue color unit pixel 96. An edge of the upper microlens 80 may be connected to the boundary between the red color unit pixel 94 and the green color unit pixel 92. Also, the edge of the upper microlens 80 may be aligned with the boundary between the blue color unit pixel 96 and the green color unit pixel 92. The upper microlens 80 may be formed on the color filter layer 70 independently from the lower microlens 60.

Therefore, the manufacturing method of the image sensor 100 according to the another embodiment of the inventive concept can remove the dead zone.

As described above, according to an embodied configuration of the inventive concept, upper and lower microlenses may be arranged by alternating in a longitudinal or a transverse direction of pixel areas on and under a color filer layer. Since the upper and lower microlenses are connected up to boundaries of unit pixels of the pixel areas, there is an effect that can remove a general dead zone. Therefore, image sensors according to embodiments of the inventive concept can increase or maximize light collection efficiency.

While this inventive concept has been particularly shown and described with reference to preferred embodiments thereof, it will be understood by those skilled in the art that various changes in form and details may be made therein without departing from the spirit and scope of the inventive concept as defined by the appended claims. The preferred embodiments should be considered in descriptive sense only and not for purposes of limitation.

What is claimed is:

1. An image sensor comprising:
a substrate comprising a plurality of pixel areas arranged in a matrix form;
a plurality of photoelectric conversion devices formed at the pixel areas;
a plurality of optical waveguide layers formed on the plurality of photoelectric conversion devices;
a color filter layer formed on the plurality of optical waveguide layers; and
upper and lower microlenses formed on and under the color filter layer, respectively,
wherein the upper and lower microlenses are arranged by alternating in longitudinal and transverse directions of the pixel area on the plurality of optical waveguide layers.

2. The image sensor of claim 1, wherein the upper and lower microlenses are arranged in a diagonal direction on one pixel area.

3. The image sensor of claim 2, wherein the pixel areas comprise a red color unit pixel, a blue color unit pixel, and a plurality of green color unit pixels,
wherein the upper microlenses are disposed on the red color unit pixel and the blue color unit pixel of the color filter layer, and the lower microlenses are disposed under the green color unit pixels of the color filter layer.

4. The image sensor of claim 3, wherein the upper and lower microlenses are connected to boundaries between the red color unit pixel, the blue color unit pixel, and the plurality of green color unit pixels on and under the color filter layer, respectively.

5. The image sensor of claim 4, further comprising interconnection layers and interlayer dielectrics formed on the substrate corresponding to the boundaries between the red color unit pixel, the blue color unit pixel, and the plurality of green color unit pixels.

6. The image sensor of claim 1, wherein the lower microlens comprises a convex lens having a higher refractive index than the optical waveguide layer.

7. The image sensor of claim 1, wherein the lower microlens comprises a concave lens having a lower refractive index than the optical waveguide layer.

8. A method of manufacturing an image sensor, the method comprising:
forming a plurality of photoelectric conversion devices in pixel areas of a substrate;
forming an optical waveguide layer on the photoelectric conversion devices;
forming lower microlenses on the optical waveguide layer corresponding to every second unit pixel in longitudinal and transverse directions of the pixel areas;
forming a color filter on the lower microlens and the optical waveguide layer; and
forming an upper microlens on the unit pixel of the color filter layer alternating with the lower microlens.

9. The method of claim 8, wherein the forming of the lower microlens comprises forming a sacrificial mask layer having a curved surface in a concave or a convex form on the optical waveguide layer, removing the sacrificial mask layer while maintaining the curved surface and removing up to an upper surface of the optical waveguide layer, and forming a lower microlens embedding the curved surface.

10. The method of claim 9, wherein the lower microlens comprises a convex lens formed along the curved surface in a concave form when the lower microlens has a higher refractive index than the optical waveguide layer.

11. The method of claim 9, wherein the lower microlens comprises a concave lens formed along the curved surface in a convex form when the lower microlens has a lower refractive index than the optical waveguide layer.

12. The method of claim 9, wherein the sacrificial mask layer is printed on the optical waveguide layer.

13. The method of claim 12, wherein the sacrificial mask layer and the optical waveguide layer are removed by a dry etching method using an etching gas having the same etch rate to each other.

14. The method of claim 8, wherein the forming of the optical waveguide layer comprises stacking interconnection layers and interlayer dielectrics on the substrate, forming a trench by removing the interlayer dielectrics on the photoelectric conversion device, and forming an optical waveguide layer inside the trench and on the interconnection layers and the interlayer dielectrics.
